(19) United States
(12) Patent Application Publication
(10) Pub. No.: US 2022/0029492 A1
(43) Pub. Date: Jan. 27, 2022

(54) ISOLATING RING, STATOR AND ELECTRIC MACHINE

(71) Applicant: JHEECO E-DRIVE AG, Eschen (LI)

(72) Inventors: Fabian LOSCH, Buchs (CH); Martin STÖCK, Salez (CH)

(21) Appl. No.: 17/311,880

(22) PCT Filed: Dec. 11, 2019
(86) PCT No.: PCT/EP2019/084753

§ 371 Date: Jun. 8, 2021

(51) Int. Cl. H02K 3/38; H02K 3/28; H02K 3/24; H02K 3/50; H02K 15/12

(52) U.S. Cl. CPC H02K 3/38; H02K 3/28; H02K 15/12; H02K 3/50; H02K 3/24

(57) ABSTRACT

The invention relates to an insulator ring for a stator, in particular for a winding head of a stator, in particular for a winding composed of rod conductors, comprising at least one first wall formed by a first hollow cylinder, where partition walls, which are formed from electrically insulating material, are arranged in a star shape on a surface of the first wall, where the partition walls extend from the end face of the stator over an axial height of the winding head.

The invention relates to an insulator ring according to the preamble of claim 1. The invention furthermore relates to a stator and an electrical machine.

A plastic cap for a winding head of a stator is known from DE 10 2015 216 322 A1. The plastic cap is configured to have the shape of a circular disk and is arranged in the region of an axial end of the winding head. Receptacles for electrical conductors of the winding head are arranged on one end of the plastic cap. The purpose of the receptacles is to insulate the electrical conductors from one another.

An electrical machine with a stator is known from WO 2017/121520. The stator comprises a rotating field winding which forms a winding head on each of the end faces, where the winding heads are embedded in heat-conducting potting material. As a result, the windings are, firstly, mechanically affixed and, secondly, electrically insulated from one another.

It is also known from prior art to insulate the rod conductors of a stator from one another with the aid of insulating paper.

Potting the winding head with resin requires a separate production step and therefore requires separate systems that are only used for this purpose. This results in additional costs for the operation and maintenance of these systems. Furthermore, additional time must be spent on the production step and post-processing. Insulating the rod conductors with insulation paper is also time-consuming. Furthermore, direct cooling of the winding head, in particular the electrically conductive elements of the winding head, is not provided or possible in the above-mentioned prior art.

The invention is therefore based on the object of specifying an insulator ring for a stator which provides reliable winding head insulation, in particular with cooling, for a winding composed of rod conductors without an additional complex production step being necessary. The invention is furthermore based on the object of specifying a stator and an electrical machine.

According to the invention, the object is satisfied with regard to
the insulator ring by the object of claim 1,
the stator by the object of claim 10
and the electrical machine by the object of claim 13.

Specifically, the object is satisfied by an insulator ring for a stator, comprising a winding composed of rod conductors, where the winding forms a winding head. The insulator ring comprises at least one first wall formed by a first hollow cylinder, where partition walls formed from electrically insulating material are arranged in a star shape on a surface of the first wall. Starting out from a stator end face, the partition walls extend over an axial height of the winding head.

The insulator ring is arranged on an end face of the stator. The region of the electrical windings projecting axially beyond the stator on one end face of the stator is referred to as the winding head. The winding head comprises rod conductors. Rod conductors are to be understood as being electrical conductors which are inserted or drawn into grooves of a laminated core. Rod conductors can be single-piece (solid conductor) or multi-piece (wire strands) and can be configured, for example, in the form of hairpins or be I-shaped (I-pins). Rod conductors can in particular also be configured as compression-molded and twisted wire strands. The stator end face is to be understood as being the end face formed by an axial end of the stator, in particular by the end of a laminated stator core.

The rod conductors comprise contact regions by way of which rod conductors are connected in pairs to form half-coils. The rod conductors can be connected or connectable directly (bent towards one another and welded) or indirectly (by way of end connectors/interconnection webs). The rod conductors preferably extend in a rectilinear manner into the winding head. In the assembled state, the partition walls of the insulator ring arranged in a star shape are arranged between the rod conductors. Starting out from a stator end face, the partition walls extend over an axial height of the winding head. The partition walls are preferably configured to be formed higher than the entire axial height of the winding head. As a result, in particular the contact regions of the rod conductors are electrically insulated from one another and preferably also mechanically affixed. The partition walls there extend inwardly or outwardly from the hollow cylinder, depending on the design of the stator.

Due to the insulator ring, no impregnating, i.e. potting the winding head with resin, is necessary. There is also no need for insulation paper. The insulation is effected by the partition walls which extend radially from the hollow cylinder. Due to the partition walls, in particular air gaps and creepage distances between the individual rod conductors are increased such that the rod conductors can be positioned at a smaller distance from one another without undercutting the normatively specified air gaps and creepage distances.

The shortest distance along a surface of a solid insulating material between two conductive elements is referred to as the creepage distance. The shortest distance between two conductive elements is referred to as the air gap.

Preferred embodiments of the invention are specified in the dependent claims.

In a preferred embodiment, a second wall, which is formed by a hollow cylinder and whose inner diameter is greater than the outer diameter of the first wall, is arranged coaxially around the first wall, and the partition walls extend radially between the first wall and the second wall. This embodiment is advantageous for all forms of rod conductors.

In a further preferred embodiment, the partition walls are formed from elastic material. This means that the partition walls are flexible and can adapt to different geometries and compensate for tolerances.

The partition walls are preferably formed to be wedge-shaped. The wedge shape can there relate to the axial extension or the radial extension of the partition walls. In other words: a section through the insulator ring tangential and/or perpendicular to a longitudinal axis of the stator results in a wedge-shaped cross section of the partition walls. The tip of the wedge is preferably formed in the direction of insertion of the insulator ring. This allows the contact regions to be braced and the contact regions are less sensitive to vibrations.

The partition walls further preferably comprise attachment elements, in particular, clamping elements or knobs. The attachment elements reduce the tendency of the rod conductors to vibrate, in particular of the contact regions of the rod conductors. As a result, the connections in the contact regions in particular are less stressed. Other types of attachment elements are conceivable. In particular, the wedge shape and the attachment elements can be combined.

In a further preferred embodiment, an annular disk is or can be connected coaxially to an end face of the first and/or the second hollow cylinder. The annular disk serves as a stop for the assembly of the insulator ring and/or as a protective cover for the contact regions of the rod conductors.

In a particularly preferred embodiment, a fluid, in particular a cooling fluid, can flow through the insulator ring, and the annular disk comprises at least one respective inlet and one outlet, where the inlet is arranged radially on the outside and the outlet is arranged radially on the inside. This enables fluid to flow from radially outside to radially inside or in the opposite direction. The fluid flow is preferably used to cool the winding head. It is conceivable that the fluid flow has radial and/or circumferential components. The partition walls can form cooling duct sections in pairs.

The partition walls advantageously comprise fluid-conducting elements. They can generate turbulence in the fluid flow to improve the heat transfer between the winding and the cooling fluid.

It is advantageous to have the insulator ring be formed in several parts. This enables the axial and/or radial assembly from the inside and/or from the outside.

In the context of the invention, a stator is disclosed and claimed, in particular for an electrical motor, with a plurality of rod conductors, where the stator comprises at least one insulator ring and the partition walls are arranged between at least some of the rod conductors.

The stator preferably comprises a plurality of electrical connection webs corresponding to the rod conductors. This makes a simple interconnection of the rod conductors possible.

Furthermore, the insulator ring is preferably pressed against a sealing mat arranged in the stator, so that a closed fluid circuit is formed. The sealing mat is therefore acted upon with a uniform surface pressure. The sealing mat is pressed in particular onto more than just one annular surface of an inner and/or outer wall. As a result, the sealing mat abuts much more rigidly against the rod conductors, which improves the sealing effect.

The sealing mat is preferably formed integrally in order to keep the number of parts low. A multi-part configuration, in particular a sectoral division into a plurality of annular sector sections around the axis of rotation and/or a radial division into a plurality of concentric sealing elements, is nevertheless possible.

In the context of the invention, an electrical machine with a stator is furthermore disclosed and claimed.

The invention shall be explained using several embodiments with reference to the accompanying schematic drawings providing further details, where:

FIG. 1 shows a perspective illustration of an embodiment according to the invention of a laminated stator core with rod conductors inserted,

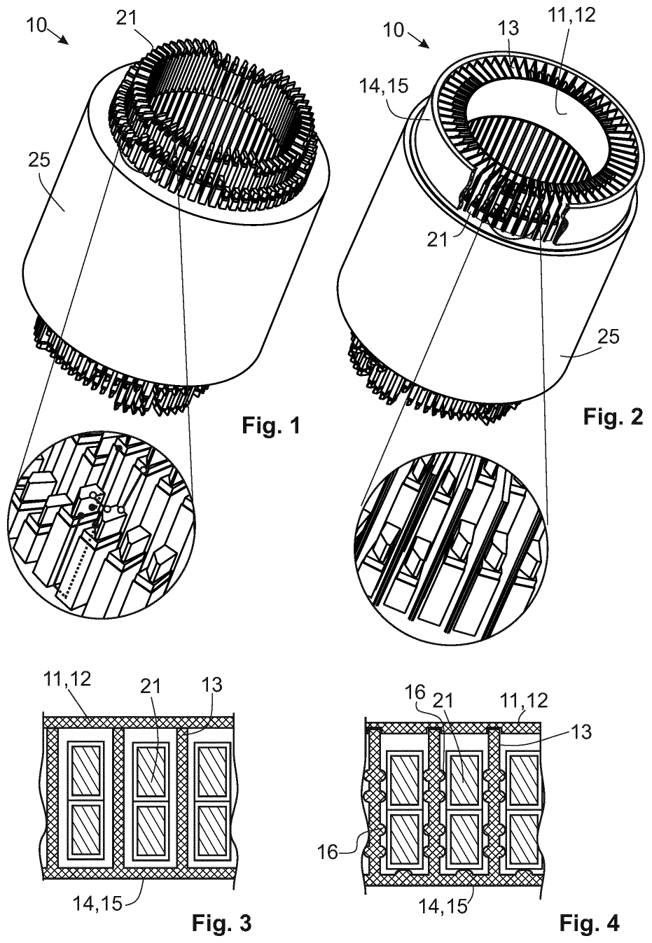

FIG. 2 shows a perspective illustration of an embodiment according to the invention of a laminated stator core with rod conductors inserted and an insulator ring,

FIG. 3 shows a schematic illustration of an embodiment according to the invention of an insulator ring without attachment elements,

FIG. 4 shows a schematic illustration of an embodiment according to the invention of an insulator ring with attachment elements,

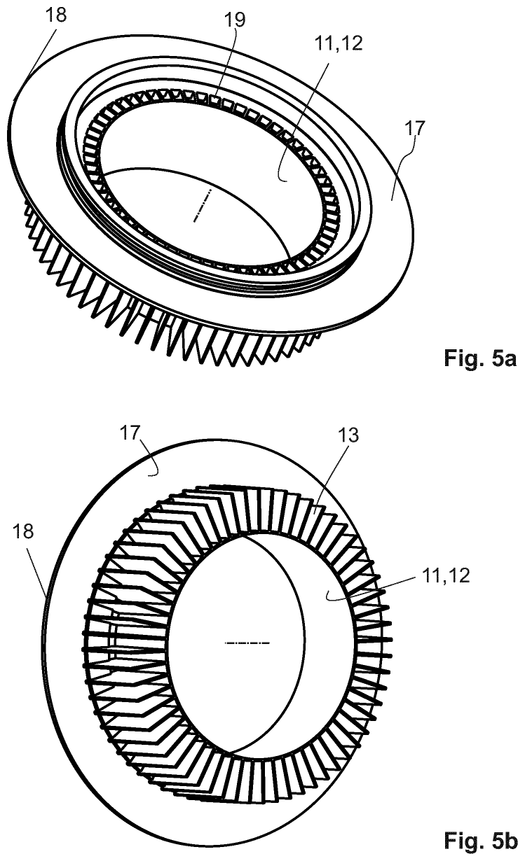

FIG. 5a shows a perspective illustration of an embodiment according to the invention of an insulator ring,

FIG. 5b shows a further perspective illustration of an embodiment according to the invention of an insulator ring according to FIG. 5a,

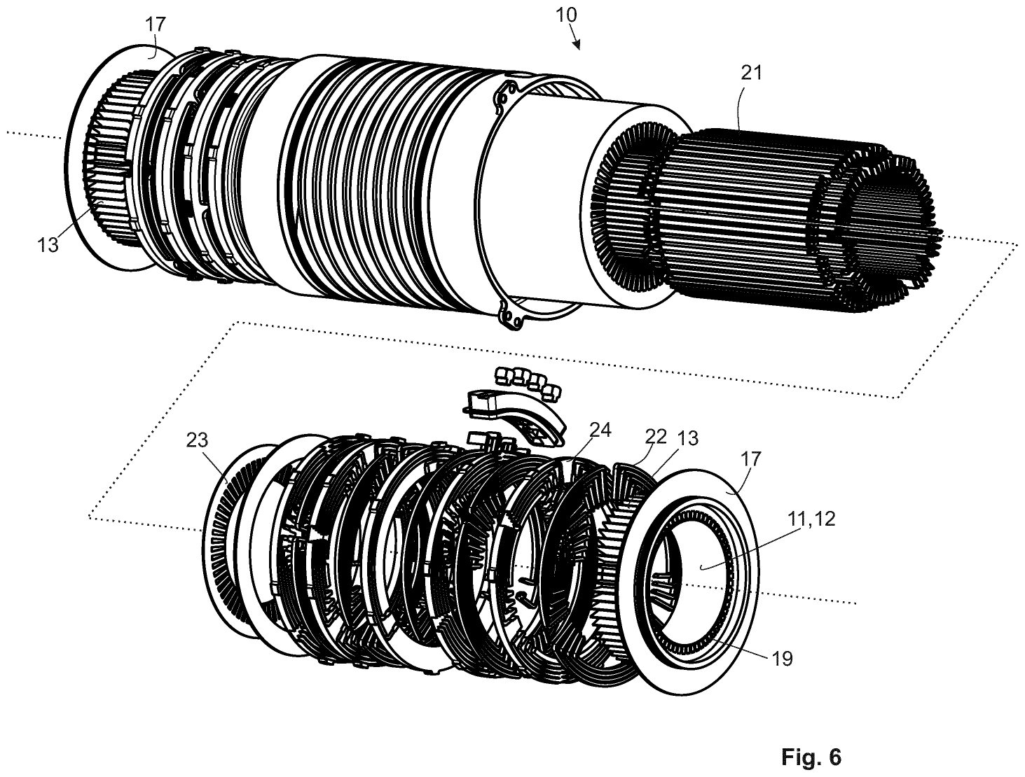

FIG. 6 shows a perspective illustration of a preferred embodiment according to the invention of a stator with an insulator ring,

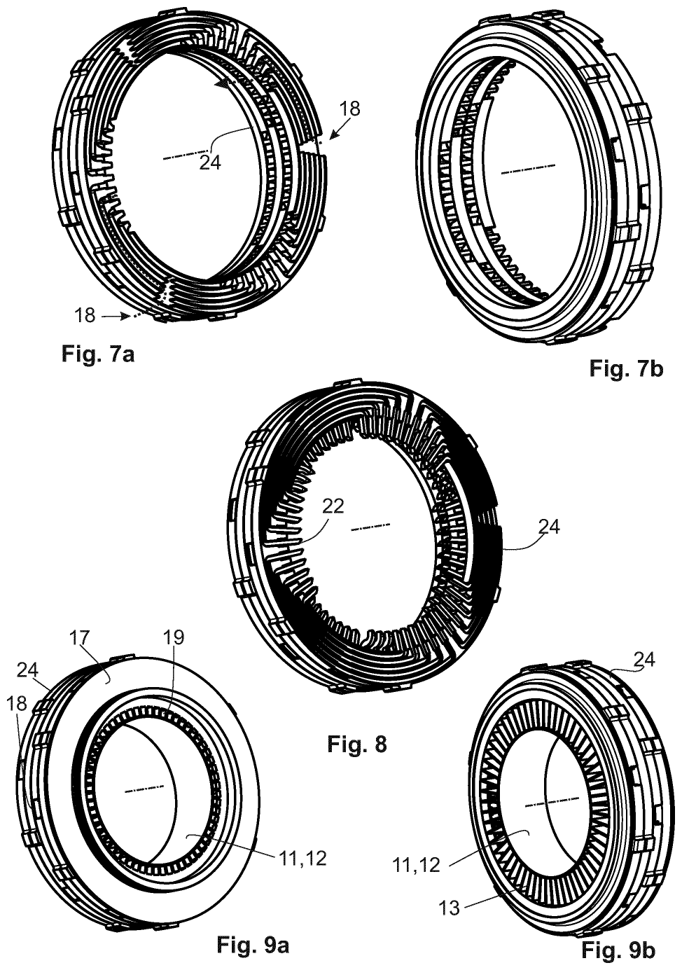

FIG. 7a shows a perspective illustration of an embodiment of a winding head with several interconnection planes,

FIG. 7b shows a further perspective illustration of an embodiment of a winding head with several interconnection planes,

FIG. 8 shows a further perspective illustration of an embodiment of a winding head with several interconnection planes,

FIG. 9a shows a perspective illustration of an embodiment according to the invention of composite interconnection planes with an insulator ring,

FIG. 9b shows a further perspective illustration of an embodiment according to the invention of composite interconnection planes with an insulator ring,

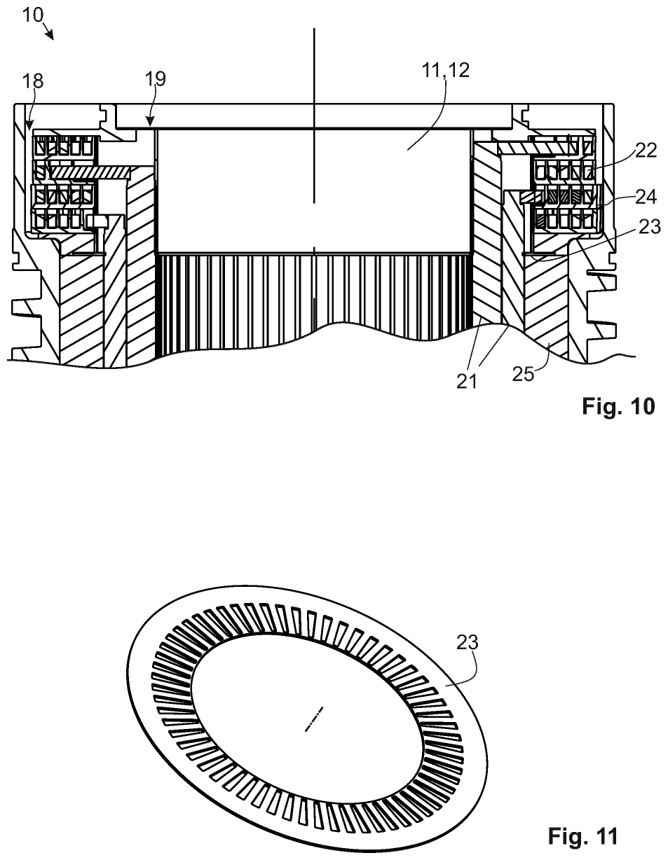

FIG. 10 shows a cross section of an embodiment of a stator,

FIG. 11 shows a perspective illustration of an embodiment according to the invention of a sealing mat,

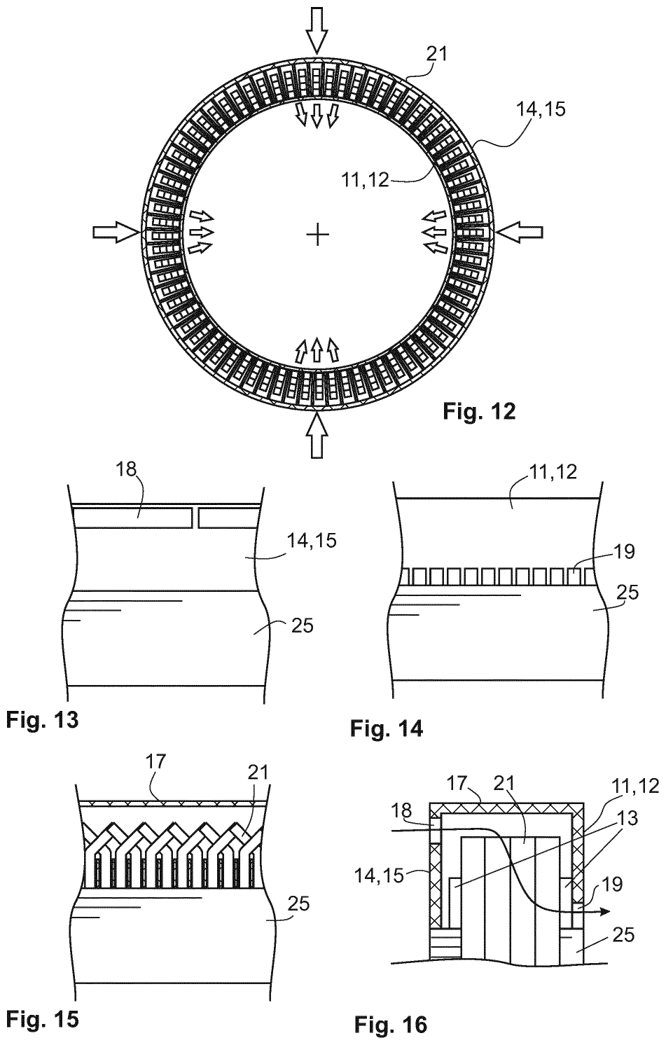

FIG. 12 shows a schematic top view of an embodiment according to the invention of a winding head with an insulator ring and fluid cooling,

FIG. 13 shows a schematic illustration of the embodiment according to the invention of FIG. 12,

FIG. 14 shows a further schematic illustration of the embodiment according to the invention of FIG. 12,

FIG. 15 shows a further schematic illustration of the embodiment according to the invention of FIG. 12,

FIG. 16 shows a further schematic illustration of the embodiment according to the invention of FIG. 12.

FIG. 1 shows an embodiment of a laminated stator core 25 of a stator 10 with rod conductors 21 inserted. Laminated stator core 25 substantially has the shape of a hollow cylinder. The laminated stator core has an end face or end surface at each of the axial ends. This can also be referred to as the stator end face. Laminated stator core 25 comprises stator grooves which extend axially on the inner side and are distributed over the circumference. Two rod conductors 21 are arranged in each of the stator grooves to form a 2-layer system. The rod conductors form part of a composite winding. Rod conductors 21 are to be understood as being, in particular, hairpins or I-pins. They can be formed in several parts as wire strands, for example, compression-molded wire strands. At their axial ends, rod conductors 21 comprise contact regions which are electrically connected directly or indirectly to create a winding.

If the different rod conductors have different voltage potentials, then they must be sufficiently insulated from one another. The creepage distances (lines with filled end points) and the air gaps (lines with unfilled end points) are shown in the enlargement. The shortest distance along a surface of a solid insulating material between two conductive elements is referred to as the creepage distance. The shortest distance between two conductive elements is referred to as the air gap.

FIG. 2 shows a laminated stator core 25 identical to FIG. 1. In FIG. 2, an insulator ring is additionally arranged on one end face. The insulator ring is arranged coaxially on laminated stator core 25. The insulator ring comprises a first wall 11 and a second wall 14. Walls 11, 14 are each formed by two hollow cylinders 12, 15 arranged concentrically to one another, where the inner diameter of second hollow cylinder 15 is greater than the outer diameter of first hollow cylinder 12. Radial partition walls 13 extend between the two walls 11, 14. Partition walls 13 are arranged as a star shape. The partition walls are configured in cross section to be uniform, in particular not wedge-shaped, parallel to a longitudinal axis of the stator and in cross section perpendicular to the longitudinal axis of the stator. In the assembled state, partition walls 13 are arranged between rod conductors 21. When viewed axially, they extend substantially from the stator end face to the axial end of the winding head. The axial end of the winding head can there be formed by the end of a rod conductor. As a result, rod conductors 21 of different grooves, in particular in the contact regions, are electrically insulated and mechanically affixed. Outside the contact regions, the rod conductors can comprise an insulating jacket that is applied, for example, as an extrudate. Rod conductors of the same groove can also be (air-) insulated from one another by way of sufficiently large distances without introducing additional material. Rod conductors of the same groove are therefore preferably formed to be of different lengths.

FIG. 3 shows a schematic top view onto a mounted insulator ring according to FIG. 2. Like in FIG. 2, partition walls 13 extend between first wall 11 and second wall 14. Rod conductors 21 are arranged between partition walls 13.

FIG. 4 is substantially identical to FIG. 3 with the difference that partition walls 13 comprise attachment elements 16. In this embodiment, they are configured as knobs or grooves which are each assigned in pairs to one rod conductor 21 and abut against the latter or clamp rod conductors 21, respectively. One or more attachment elements can be provided. The attachment elements can be configured to be end-to-end or discontinued along the longitudinal axis of the stator. Attachment elements 16 thus reduce the tendency of rod conductors 21 to vibrate. Other shapes of attachment elements 16 are conceivable. Partition walls 13 are furthermore affixed in a positive-fit manner in the first wall. The positive fit is configured as a tongue and groove connection. This increases the rigidity of the assembly.

FIGS. 5a and 5b show a further embodiment of an insulator ring. The insulator ring comprises a first wall 11, partition walls 13, and an annular disk 17. First wall 11 is formed by a hollow cylinder 12. Partition walls 13 are arranged on the outer side of first wall 11 distributed over the circumference. In contrast to the insulator ring described in the previous figures, the one presently described does not comprise a second wall 14. The partition walls extend freely radially outwardly. Annular disk 17 is arranged coaxially on an end face of first wall 11. The outer diameter of annular disk 17 is dimensioned in such a way that annular disk 17 projects beyond partition walls 13. An annular extension is arranged on annular disk 17. The annular extension comprises a groove extending over the outer circumference. The groove serves to accommodate a seal, in particular an O-ring.

The insulator ring illustrated further comprises an inlet 18 and an outlet 19 for a fluid, in particular for a cooling fluid, which can be connected to a fluid circuit. Inlet 18 is arranged on the radially outer edge of annular disk 17. Inlet 18 is configured as a circular gap between the outer edge of annular disk 17 and the housing shown in FIG. 6. The inner diameter of annular disk 17 is larger than the outer diameter of hollow cylinder 12. Annular disk 17 is arranged on one axial end of partition walls 13. As a result, an annular gap is formed between first wall 11 and annular disk 17. The annular gap forms outlet 19 for the fluid. The cooling fluid substantially flows from inlet 18 at the outer edge of annular disk 17 to outlet 19 arranged radially inside. The cooling fluid flows therebetween through the winding head and partition walls 13 of the insulator ring before it exits outlet 19 again. It is conceivable that the fluid flow has radial and/or circumferential components. It is also conceivable that partition walls 13 comprise fluid-conducting elements in order to improve the heat transfer between the regions to be cooled, in particular rod conductors 21 and/or connection webs 22, and the cooling fluid. For this purpose, for example, noses, protrusions and/or depressions can be applied to the partition walls which extend longitudinally and/or transversely to the direction of flow of a fluid. Conceivable are also throttle gaps formed by accentuation of a partition wall 13 and a side surface of a rod conductor 21, for example, for selectively creating turbulence in the flow in this region.

FIG. 6 shows an embodiment of a stator 10 in the assembled state in an exploded view. Stator 10 shown is suitable for generating a rotating magnetic field for asynchronous machines as well as for synchronous machines. Stator 10 comprises an insulator ring corresponding substantially to the insulator ring from FIGS. 5a and 5b, a laminated stator core 25 with rod conductors 21 according to FIGS. 1 and 2, a housing and two winding heads, where one winding head each is arranged at one axial end of stator 10. The region of the electrical windings projecting axially beyond stator 10 is referred to as the winding head.

The winding head in the actual sense comprises the contact regions of individual rod conductors 21 and electrically conductive connection webs 22. In the broader sense, the winding head also comprises insulator disks 24, a sealing mat 23, and the insulator ring.

Rod conductors 21 are arranged in the stator grooves of laminated stator core 25. Laminated stator core 25 is arranged coaxially in a housing. Arranged coaxially on the axial end of laminated stator core 25 facing away from the center of the stator is sealing mat 23 in such a way that sealing mat 23 rests in a sealing manner on the stator grooves. The interconnection planes are arranged on sealing mat 23. The interconnection planes are formed from connection webs 22, insulator disks 24, and contact regions of rod conductors 21. The insulator ring with cover part 17 is arranged on the last interconnection plane. Partition walls 13 of the insulator ring extend axially across all interconnection planes.

With a view onto FIG. 6, FIGS. 7a, 7b and 8 show different perspective illustrations of the interconnection planes in the assembled state. Where insulator disks 24, which electrically insulate connection webs 22 from one another, can be clearly seen (without interconnection webs 22) in FIGS. 7a and 7b. In FIG. 8, insulator disks 24 with inserted connection webs 22 connecting rod conductors 21 to one another can be clearly seen.

FIGS. 9a and 9b show the insulator ring in the assembled state with connection webs 22 and insulator disks 24. FIG. 9a shows a perspective view from above and FIG. 9b shows a perspective view from below. Connection webs 22 and insulator disks 24 form an essential part of the winding head. In the assembly formed from connection webs 22 and insulator disks 24, the insulator ring is arranged coaxially in such a way that annular disk 17 rests closely, in particular in a sealing manner, upon an interconnection plane at the end face. For this purpose, the insulator ring can be acted upon axially with a compressive force.

FIG. 10 shows a section through an embodiment of stator 10. Stator 10 comprises a winding head, rod conductor 21, connection webs 22, and an insulator ring. Sealing mat 23 is arranged at the end of the insulator ring which is disposed axially in the installation direction. Sealing mat 23 rests on the stator grooves. The insulator ring exerts a uniform surface pressure upon sealing mat 23. More uniform distribution of the contact pressure improves the sealing effect of sealing mat 23. For this purpose, the insulator ring can be acted upon axially with a compressive force.

FIG. 11 shows sealing mat 23 from FIGS. 6 and 10. Sealing mat 23 made of elastic material is formed in the shape of an annular disk. Sealing mat 23 comprises narrow, elongate openings which are arranged in the circumferential direction. In other words, the openings are configured as slots which taper towards the center of sealing mat 23 and which correspond to the shape of the stator grooves or the rod conductors, respectively, but are formed to be smaller. Other shapes are also conceivable. Arranged in the openings are rod conductors 21, which in the installed state elastically expand the openings of sealing mat 23. The openings are therefore advantageously adapted to the geometry of rod conductors 21.

FIGS. 12-16 show an embodiment of a winding head formed from rod conductors 21 that are connected directly to one another.

FIG. 12 shows an embodiment of an insulator ring with fluid cooling. The insulator ring comprises a first wall 11 and a second wall 14 between which partition walls 13 are arranged in a star shape. Rod conductors 21, in particular the contact regions of rod conductors 21, are arranged between partition walls 13. Rod conductors 21 are formed as hairpins (not shown). Other types of rod conductors 21 are alternatively conceivable. Rod conductors 21 are arranged in grooves of a laminated stator core. The winding is formed to have four layers so that each groove comprises four rod conductors. The cooling fluid flows radially from the outside to the inside. It is there conceivable that the flow direction is radial only in part. It is conceivable in particular that the fluid flow runs radially in part and in part in the circumferential direction of the insulator ring.

FIG. 13 shows a side view of second wall 14 of the insulator ring shown in FIG. 12. The insulator ring is arranged on laminated stator core 25. Second wall 14 comprises inlet 18 for the cooling fluid. In this embodiment, inlet 18 is configured as a partially discontinued gap which extends over the circumference of second wall 14. This means that the distances between the gaps are so small that an annular gap is substantially formed. Other shapes of inlet 18 are conceivable. Inlet 18 extends over the entire circumference of second wall 14. More precisely, inlet 18 is arranged in second wall 14 in the direction of the axial end of the insulator ring facing away from laminated stator core 25.

FIG. 13 shows a side view of first wall 14 of the insulator ring shown in FIG. 12. First wall 11 comprises inlet 19 for the cooling fluid. Outlet 18 is arranged at the axial end of first wall 11 facing laminated stator core 25. Outlet 19 is configured as openings distributed over the circumference of first wall 11, where the width of the openings preferably corresponds to the distance between partition walls 13. Other shapes, for example, an annular gap, are conceivable for outlet 19.

FIG. 15 shows a section through the insulator ring. Annular disk 17 is arranged on the axial end facing away from the laminated stator core. The contact regions of rod conductors 21 are arranged between annular disk 17 and the laminated stator core. Rod conductors 21 are configured as hairpins. A hairpin is a rod conductor formed as one piece and bent into a U-shape or hairpin-shape and runs through two different stator grooves. A hairpin therefore needs to be contacted on one side of a laminated stator core only. Partition walls 13 are arranged between rod conductors 21. Partition walls 13 are formed to have half the height. As a result, partition walls 13 can be arranged, in particular be pushed in, between the hairpins. The insulator ring is therefore advantageously configured to have several parts in this embodiment. It is advantageous to have the partition walls be configured to be elastic in order to arrange them more easily between the hairpins. It is possible in particular to dispense with a, for example, brittle ceramic insulation jacket applied to the hairpins, which would be at risk of fracturing or cracking due to the bending of the rod conductor. FIG. 16 shows a cross section of the insulator ring according to FIGS. 12 to 15. As already described in FIGS. 12 to 15, the insulator ring comprises an inlet 18 which is arranged on second wall 14, and an outlet 19 which is arranged on first wall 11. Arranged between first wall 11 and second wall 14 are rod conductors 21 which are configured as hairpins in the circumferential direction. Partition walls 13 of half the height are arranged between the hairpins. Partition walls 13 extend from first wall 11 to just up to second wall 14. This means that partition walls 13 are only connected or connectable to first wall 11. In order to arrange the insulator ring on the winding head such that partition walls 13 can be arranged between the hairpins, it is advantageous to first mount first wall 11 together with partition walls 13 on the winding head and thereafter to attach second wall 14. The arrow describes the direction of the fluid flow in the insulator ring. The fluid accordingly flows radially from inlet 18 in the direction of outlet 19.

### LIST OF REFERENCE CHARACTERS

10 stator
11 first wall
12 first hollow cylinder
13 partition wall
14 second wall
15 second hollow cylinder
16 attachment elements
17 annular disk
18 inlet
19 outlet
21 rod conductor
22 connection web
23 sealing mat
24 insulator disk
25 laminated stator core

1. Insulator ring for a stator comprising a winding composed of rod conductors which forms a winding head, where said insulator ring comprises at least one first wall formed by a first hollow cylinder, where partition walls, which are formed from an electrically insulating material, are arranged on a surface of said first wall in a star shape, said partition walls, starting from a stator end face, extend over an axial height of said winding head.

2. Insulator ring according to claim 1, wherein a second wall, which is formed by a second hollow cylinder and whose inner diameter is greater than outer diameter of said first wall, is arranged coaxially around said first wall, and said partition walls extend radially between said first wall and said second wall.

3. Insulator ring according to claim 1, wherein said partition walls are formed from elastic material.

4. Insulator ring according to claim 1, wherein said partition walls are formed to be wedge-shaped.

5. Insulator ring according to claim 1, wherein said partition walls comprise attachment elements.

6. Insulator ring according to claim 1, wherein an annular disk is coaxially connected or connectable to an end face of said first hollow cylinder and said second hollow cylinder.

7. Insulator ring according to claim 6, wherein fluid is configured to flow through said insulator ring, and said annular disk comprises at least one respective inlet and one outlet, where said inlet is arranged radially outside and said outlet radially inside.

8. Insulator ring according to claim 7, wherein said partition walls comprise fluid-conducting elements.

9. Insulator ring according to claim 1, wherein said insulator ring is formed to have several parts.

10. Stator, in particular for an electrical motor, with a plurality of rod conductors, where said stator comprises at least one insulator ring according to claim 1 and said partition walls are arranged between at least some of said rod conductors.

11. Stator according to claim 10, wherein said stator comprises a plurality of connection webs corresponding to said rod conductors.

12. Stator according to claim 10, wherein at least one insulator ring is pressed against a sealing mat arranged in said stator, so that a closed fluid circuit is formed.

13. Electrical machine with a stator according to claim 10.

14. Insulator ring according to claim 2, wherein said partition walls are formed from elastic material.

15. Insulator ring according to claim 14, wherein said partition walls are formed to be wedge-shaped.

16. Insulator ring according to claim 1, wherein said partition walls comprise clamping elements or knobs.

17. Insulator ring according to claim 15, wherein said partition walls comprise clamping elements or knobs.

18. Insulator ring according to claim 1, wherein an annular disk is coaxially connected or connectable to an end face of said first hollow cylinder or said second hollow cylinder.

19. Insulator ring according to claim 6, wherein cooling fluid is configured to flow through said insulator ring, and said annular disk comprises at least one respective inlet and one outlet, where said inlet is arranged radially outside and said outlet radially inside.

20. Insulator ring according to claim 17, wherein cooling fluid is configured to flow through said insulator ring, and said annular disk comprises at least one respective inlet and one outlet, where said inlet is arranged radially outside and said outlet radially inside.
